(19) United States
(12) Patent Application Publication
(10) Pub. No.: US 2024/0144124 A1
(43) Pub. Date: May 2, 2024

(54) METHODS AND SYSTEMS FOR COLOCATION OF PLURALITY OF BUSINESS SERVICES

(71) Applicant: Alipay (Hangzhou) Information Technology Co., Ltd., Hangzhou (CN)

(72) Inventors: Hao DAI, Hangzhou (CN); Tongkai YANG, Hangzhou (CN); Wei WU, Hangzhou (CN)

(21) Appl. No.: 18/494,417

(22) Filed: Oct. 25, 2023

(30) Foreign Application Priority Data
Oct. 27, 2022 (CN) 202211325213.2

(51) Int. Cl. G06Q 10/0631

(52) U.S. Cl. CPC G06Q 10/06312

(57) ABSTRACT

Embodiments of this specification disclose methods and systems for colocation of a plurality of business services. The method includes: for one of the business services, determining a target resource level corresponding to the business service; obtaining a target schedulable resource of each of one or more processing devices, where the target schedulable resource is a schedulable resource corresponding to the target resource level; and determining, based on whether the target schedulable resource satisfies a deployment condition corresponding to the business service, a method for deploying the business service on the one or more processing devices.

### TECHNICAL FIELD

This specification relates to the field of data processing technologies, and in particular, to a method and system for colocation of a plurality of business services.

### BACKGROUND

The scale of the modern Internet data center is becoming larger and larger with an increasing demand for business services. However, low utilization of resources in the data center gradually becomes a constraint factor for further development of computation. In an existing business service colocation technology, several types of business services (for example, offline businesses and online businesses) can be co-located on a device to make full use of device resources (for example, computing resources or memory resources). However, types of businesses co-located by the existing business service colocation technology are single, and it is not easy to co-locate a plurality of types of business services. In addition, when a plurality of types of business services are co-located, problems such as resource contention and resource interference are prone to occur between the business services, which poses a great challenge to business service stability.

Therefore, a method and system for colocation of a plurality of business services are urgently needed to better co-locate a plurality of types of business services, and a resource scheduling method for colocation of a plurality of business services is urgently needed to ensure running stability of business services co-located on a device while improving device resource utilization.

### SUMMARY

An aspect of embodiments of this specification provides a method for colocation of a plurality of business services. The method includes: for one of the business services, a target resource level corresponding to the business service is obtained; a target schedulable resource of each of one or more processing devices is obtained, where the target schedulable resource is a schedulable resource corresponding to the target resource level; and a method for deploying the business service on the one or more processing devices is determined based on whether the target schedulable resource satisfies a deployment condition corresponding to the business service.

Another aspect of embodiments of this specification provides a system for colocation of a plurality of business services. The system includes a first level determining module, a guaranteed resource determining module, and a deployment module. For one of the business services, the first level determining module is configured to determine a target resource level corresponding to the business service; the guaranteed resource determining module is configured to obtain a target schedulable resource of each of one or more processing devices, where the target schedulable resource is a schedulable resource corresponding to the target resource level; and the deployment module is configured to determine, based on whether the target schedulable resource satisfies a deployment condition corresponding to the business service, a method for deploying the business service on the one or more processing devices.

Another aspect of embodiments of this specification provides an apparatus for colocation of a plurality of business services. The apparatus includes at least one processor and at least one memory. The at least one memory is configured to store computer instructions. The at least one processor is configured to execute at least a part of the computer instructions to implement the method for colocation of a plurality of business services provided in embodiments of this specification.

Another aspect of embodiments of this specification provides a resource scheduling method for colocation of a plurality of business services. The method includes: a plurality of resource levels corresponding to the plurality of business services are determined, and for any one of the resource levels, a guaranteed resource and level resource usage that correspond to the resource level are determined, where the level resource usage is determined by summing allocated resources of one or more business services corresponding to the resource level; and allocated resources of one or more business services that satisfy a selection condition and that correspond to the resource level are adjusted in a predetermined method in response to that the level resource usage and the guaranteed resource satisfy a first relationship or a second relationship, where the predetermined method corresponding to the first relationship includes increasing the allocated resources of the business service, and the predetermined method corresponding to the second relationship includes decreasing the allocated resources of the business service.

Another aspect of embodiments of this specification provides a resource scheduling system for colocation of a plurality of business services. The system includes a second level determining module, a second resource determining module, and an adjustment module. The second level determining module is configured to determine a plurality of resource levels corresponding to the plurality of business services, and for any one of the resource levels, the second resource determining module is configured to determine a guaranteed resource and level resource usage that correspond to the resource level, where the level resource usage is determined by summing allocated resources of one or more business services corresponding to the resource level; and the adjustment module is configured to adjust, in a predetermined method in response to that the level resource usage and the guaranteed resource satisfy a first relationship or a second relationship, allocated resources of one or more business services that satisfy a selection condition and that correspond to the resource level, where the predetermined method corresponding to the first relationship includes increasing the allocated resources of the business service, and the predetermined method corresponding to the second relationship includes decreasing the allocated resources of the business service.

Another aspect of embodiments of this specification provides a resource scheduling apparatus for colocation of a plurality of business services. The apparatus includes at least one processor and at least one memory. The at least one memory is configured to store computer instructions. The at least one processor is configured to execute at least a part of the computer instructions to implement the resource scheduling method for colocation of a plurality of business services provided in embodiments of this specification.

### BRIEF DESCRIPTION OF DRAWINGS

This specification is further described by using example embodiments, and these example embodiments are described in detail with reference to the accompanying drawings. These embodiments are not limiting. In these embodiments, the same reference numeral represents the same structure.

FIG. 1 is an example diagram illustrating an application scenario of a system for colocation of a plurality of business services, according to some embodiments of this specification;

FIG. 2 is an example flowchart illustrating a method for colocation of a plurality of business services, according to some embodiments of this specification;

FIG. 3 is an example flowchart illustrating determining a target resource profile of a processing device, according to some embodiments of this specification;

FIG. 4 is an example schematic diagram illustrating a resource scheduling method for colocation of a plurality of business services, according to some other embodiment of this specification;

FIG. 5 is an example diagram illustrating modules of a system for colocation of a plurality of business services, according to some embodiments of this specification; and

FIG. 6 is an example diagram illustrating modules of a resource scheduling system for colocation of a plurality of business services, according to some embodiments of this specification.

### DESCRIPTION OF EMBODIMENTS

To describe the technical solutions in embodiments of this specification more clearly, the following briefly describes the accompanying drawings needed for describing the embodiments. Clearly, the accompanying drawings in the following descriptions merely illustrate some examples or embodiments of this specification, and a person of ordinary skill in the art can still apply this specification to other similar scenarios based on these accompanying drawings without creative efforts. Unless clear from the language environment or otherwise stated, the same reference numeral in the figure represents the same structure or operation.

It should be understood that the terms “system”, “apparatus”, “unit”, and/or “module” used in this specification are used to distinguish between different components, elements, parts, portions, or assemblies of different levels. However, if other words can achieve the same purpose, the term can be replaced by other expressions.

As shown in this specification and the claims, the terms “one”, “a”, and/or “the”, etc. is unnecessarily in a singular form, and can be in a plural form unless the context expressly suggests exceptions. Generally, the terms “include” and “contain” indicate only those steps and elements that have been explicitly identified, these steps and elements do not constitute an exclusive listing, and the method or device can also include other steps or elements.

A flowchart is used in this specification to describe operations performed by a system according to embodiments of this specification. It should be understood that the operations may not be precisely performed in sequence. Instead, the steps can be processed in reverse sequence or simultaneously. In addition, other operations can be added to these processes, or one or more operations can be removed from these processes.

In an aspect, in a technology for colocation of a plurality of types of business services, it is not easy to co-locate a plurality of business services due to various reasons. For example, if colocation of business services is insufficient, that is, a quantity of resources used by a plurality of co-located business services occupies only a small part of device resources (for example, when a plurality of types of business services are co-located on a device, device resources are statically divided into a plurality parts based on a proportion and allocated to the busies services, and a quantity of resources used by the business services occupies only a small part of the allocated resources), a large quantity of device resources of the device is idle, and resource utilization is low, causing an increase in costs of the device running the business services. For another example, if colocation of business services is excessive, that is, a quantity of resources used by a plurality of co-located business services exceeds a quantity of device resources (for example, when a plurality of types of business services are co-located on a device, device resources are statically divided into a plurality parts based on a proportion and allocated to the busies services, and a quantity of resources used by the business services exceeds a quantity of allocated resources), running stability of the business services on the device is reduced, causing a fault. Based on this, in this specification, the method for colocation of a plurality of business services is proposed to better co-locate a plurality of types of business services, improve resource utilization of device resources, reduces costs of a device running the business services, and effectively avoids problems such as insufficient and excessive colocation.

In another aspect, in a technology for colocation of a plurality of business services, when a plurality of co-located business services run on a device, because an actual quantity of resources used by each business service to run constantly changes, allocated resources corresponding to one or more business services are prone to be insufficient. As a result, resource utilization of the allocated resources is excessively high, and the corresponding business service is damaged; or all device resources of a device are allocated, but actual resource utilization of the allocated resources corresponding to each business service is low. Based on this, in this specification, the resource scheduling method for colocation of a plurality of business services is proposed to dynamically adjust allocated resources of co-located business services, so as to make full use of device resources, and prevent excessively high resource utilization of the allocated resources corresponding to the business services from affecting service running stability, thereby improving running stability of the co-located business service.

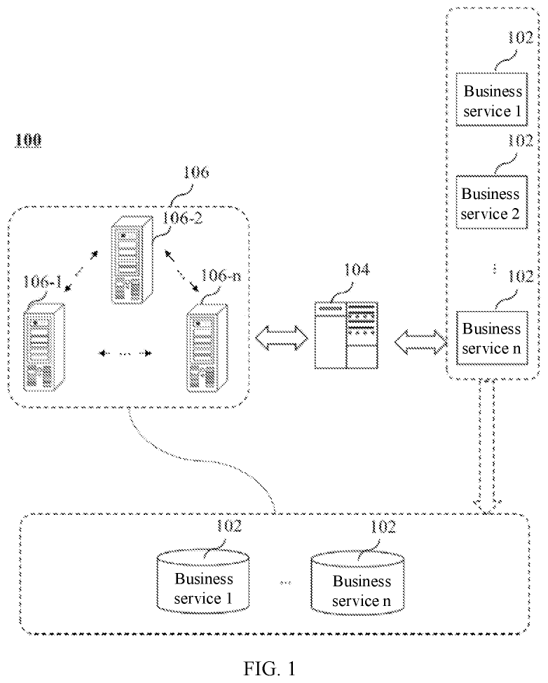

FIG. 1 is an example diagram illustrating an application scenario of a system for colocation of a plurality of business services, according to some embodiments of this specification.

The application scenario 100 of the system for colocation of a plurality of business services can include a plurality of business services 102 (for example, business service 1, business service 2, . . . , and business service n), a processor 104, and a device 106.

In some embodiments, the system for colocation of a plurality of business services can determine a method for deploying each business service 102 on the device 106. For example, the system for colocation of a plurality of business services determines to deploy the business service 102 on a processing device in the device 106. For another example, the system for colocation of a plurality of business services determines that the business service 102 fails to be deployed on the device 106. Therefore, the system for colocation of a plurality of business services can implement colocation of a plurality of types of business services on the device 106.

The business service 102 can be a business service that needs to be deployed on the device 106. The business service 102 can include various business services corresponding to business fields. For example, the business service can include a payment service, a query service, etc. For another example, the business service 102 can further include various business services in various service fields, such as an online service, real-time computation, and offline computation. The business service 102 can be deployed on a processing device in the device 106, so as to run the business service 102 on the device 106 (for example, a program and a process corresponding to the business service 102 are deployed on the device 106, so as to compute, on the device 106, related business data corresponding to the business service 102 to implement a corresponding business objective). The business service 102 can be processed into various feasible business forms to be deployed on the device. For example, the business service 102 can be in various business forms such as a virtual machine (a corresponding business service can run in the virtual machine) and a container (a corresponding business service can run in the container) that implement a corresponding business service.

The device 106 can include one or more processing devices (for example, a cluster or group including a plurality of processing devices). The processing device can include any type of physical machine, processor, system, platform, etc. that can be used to deploy and run a business service, or any combination of the above devices. As shown in FIG. 1, the device 106 can include a processing device 106-1, a processing device 106-2, . . . , and a processing device 106-n.

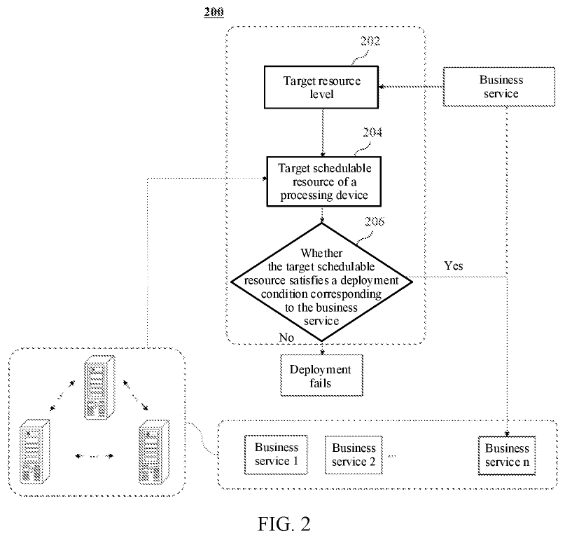

The processor 104 can process data and/or information obtained from another device or a component of the application scenario. The processor 104 can execute program instructions based on the data, the information, and/or a processing result to perform one or more functions described in this specification. For example, for one of the business services 102, the processor 104 can determine a target resource level corresponding to the business service; can obtain a target schedulable resource of each of one or more processing devices in the device 106, where the target schedulable resource is a schedulable resource corresponding to the target resource level; and can determine, based on whether the target schedulable resource satisfies a deployment condition corresponding to the business service, a method for deploying the business service on the one or more processing devices. For more content of the method for deploying the business service 102 on the one or more processing devices, references can be made to FIG. 2 and related descriptions of the figure. In some embodiments, the processor 104 can be implemented by the processing device in the device 106. In some embodiments, the processor 104 can alternatively be implemented by another processor other than the device 106.

It is worthwhile to note that the application scenario is provided only for the purpose of description, and is not intended to limit the scope of this specification. A person of ordinary skill in the art can make various modifications or changes based on the description of this specification. For example, the application scenario can further include a database. For another example, the application scenario can implement similar or different functions on another device. However, the changes and modifications do not depart from the scope of this specification.

FIG. 2 is an example flowchart illustrating a method for colocation of a plurality of business services, according to some embodiments of this specification.

In some embodiments, for a business service, a system for colocation of a plurality of business services can perform a procedure 200 to determine a method for deploying the business service on one or more processing devices. All of a plurality of business services can be deployed in sequence according to the procedure 200, so that a plurality of business services are co-located on one or more processing devices. As shown in FIG. 2, the procedure 200 can include the following steps.

Step 202: Determine a target resource level corresponding to the business service.

In some embodiments, step 202 can be performed by a first level determining module 502.

A resource level can reflect a priority or importance of a resource. A resource level corresponding to a current business service (that is, a resource level corresponding to a resource used by the current business service) is referred to as the target resource level.

Resource levels can include a plurality of resource levels ranging from low to high. For example, the resource levels can be divided into a plurality of resource levels: high protection, medium protection, and low protection. High protection can be a predetermined highest resource level. When a target resource level corresponding to a business service is high protection, it indicates that a priority or importance of a resource used by the business service is high. Device resources in a processing device can be preferentially configured to deploy and/or run the business service. Low protection can be a predetermined lowest resource level. When a target resource level corresponding to a business service is low protection, it indicates that a priority or importance of a resource used by the business service is low. Device resources in a processing device can be configured to preferentially deploy and/or run another business service with a higher resource level, and the business service is deployed and/or run based on the remaining device resources.

In some embodiments, the first level determining module 502 can determine the target resource level corresponding to the business service in a plurality of methods. For example, the first level determining module 502 can obtain a business protocol (which can be determined based on a business requirement or a user requirement, and can include a predetermined mapping relationship between each type of business service and each resource level) corresponding to the business service, and determine, based on the business protocol, the target resource level corresponding to the business service.

Business service-related information such as resource levels corresponding to business services can be recorded or stored in various feasible methods, so as to be obtained when required.

Step 204: Obtain a target schedulable resource of each of one or more processing devices.

In some embodiments, step 204 can be performed by a first resource determining module 504.

The target schedulable resource is a schedulable resource corresponding to the target resource level. Device resources of processing devices (for example, total quantities of resources of the devices) in the one or more processing devices may be different, and therefore, target schedulable resources on different processing devices may be different. The first resource determining module 504 can determine the target schedulable resource of each processing device.

In some embodiments, for one of the processing devices, the first resource determining module 504 can determine a target resource profile of the processing device, where the target resource profile is a resource profile corresponding to the target resource level.

The resource profile can reflect resource usage, and can include resource usage data such as estimated resource usage. For example, the resource profile corresponding to the resource level can include resource usage data such as estimated resource usage corresponding to the resource level.

In some embodiments, the first resource determining module 504 can determine the target resource profile of the processing device in a plurality of methods.

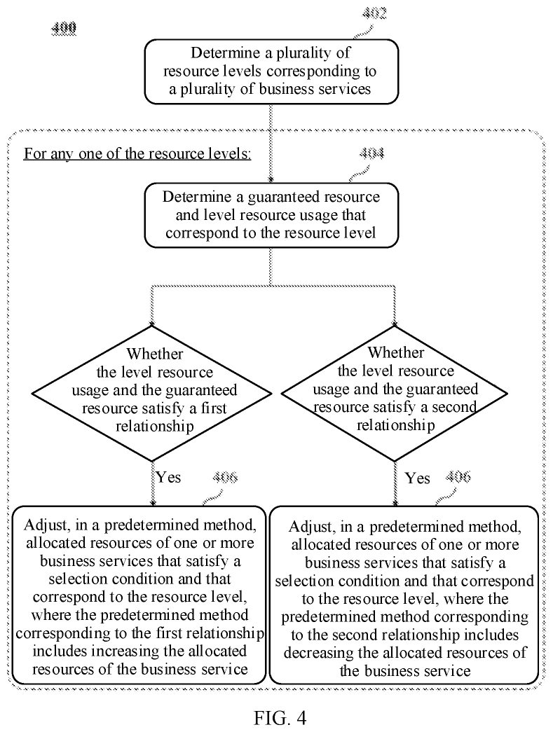

In some embodiments, the first resource determining module 504 can obtain a business resource profile of an existing business service corresponding to the target resource level on the processing device (the existing business service is referred to as a target business service in this specification, and the existing business service is a business service that has been deployed on the processing service), and can determine the target resource profile of the processing device based on business resource profiles of all target business services on the processing device. For more descriptions of the embodiments for determining the target resource profile, references can be made to FIG. 4 and related descriptions of the figure.

In some embodiments, the first resource determining module 504 can alternatively determine the target resource profile of the processing device in other methods. For example, when there is no target business service on the processing device, the first resource determining module 504 can determine the target resource profile corresponding to the target resource level based on a predetermined resource profile. The predetermined resource profile is a resource profile corresponding to a predetermined resource level, and can be determined based average usage of resources at the resource levels of a plurality of processing devices (for example, average usage of resources at the resource levels of the plurality of processing devices in historical time), or can be determined based on a business requirement or a user requirement.

In some embodiments, the first resource determining module 504 can determine a guaranteed resource corresponding to the target resource level. The guaranteed resource can reflect a quantity of resources required to ensure that a business service corresponding to the resource level can be deployed and/or run, for example, can be a maximum quantity of guaranteed resources. In some embodiments, the first resource determining module 504 can determine guaranteed resources corresponding to the resource levels in a plurality of methods. For example, the guaranteed resources corresponding to the resource levels can be predetermined based on a business requirement and a user requirement, and further, the guaranteed resources corresponding to the resource levels are determined based on predetermined data.

In some embodiments, the first resource determining module 504 can determine the target schedulable resource of the processing device based on the guaranteed resource and the target resource profile corresponding to the target resource level, and device resources of the processing device.

The first resource determining module 504 can obtain the device resources of the processing device by using device metadata or other feasible methods. The device resources can be a total quantity of resources of the device.

In some embodiments, the first resource determining module 504 can determine the target schedulable resource of the processing device based on formula (1):

Rᵢⁿ=(Tᵢ/P_{Maxi})*Lⁿ (1)

where Rᵢⁿ represents a target schedulable resource of a processing device n corresponding to a target resource level, Tᵢ represents a guaranteed resource corresponding to the target resource level i, Pₘₐₓᵢ represents a target resource profile of the processing device n corresponding to the target resource level i, and Lⁿ represents device resources of the processing device n.

In some embodiments, when the target resource level is a predetermined lowest resource level, the first resource determining module 504 can obtain usage of one or more other business resources corresponding to one or more other business services on the processing device, and can determine the target schedulable resource of the processing device based on the usage of the one or more other business resources and the device resources of the processing device.

Other business services are existing business services corresponding to other resource levels on the processing device. Resource usage of other business services is referred to usage of other business resources. The first resource determining module 504 can obtain usage of one or more other business resources in the processing device by using device metadata or other feasible methods.

When one another business service is deployed on the processing device, the first resource determining module 504 can obtain usage of another business resource corresponding to the another business service. When a plurality of other business services are deployed on the processing device, the first resource determining module 504 can obtain usage of another business resource corresponding to each of the plurality of other business services.

In some embodiments, when the target resource level is a predetermined lowest resource level, the first resource determining module 504 can determine the target schedulable resource of the processing device based on formula (2):

$${R}_{mini}^{n} = {L}^{n} - {\sum }_{i = mini + 1}^{maxi} {U}_{i} \qquad ( 2 )$$

where Rₘᵢₙᵢⁿrepresents a target schedulable resource of a processing device n corresponding to a predetermined lowest resource level mini when the target resource level is the predetermined lowest resource level mini, Lⁿ represents device resources of the processing device n, Uᵢ represents usage of other business resources, and Σₘᵢₙᵢ₊₁^{maxi}Uᵢ represents a sum of usage of other business resources corresponding to other resource levels higher than the predetermined lowest resource level mini (that is, the resource levels are mini+1˜maxi).

When the target resource level is the predetermined lowest resource level, in some embodiments of this specification, the target schedulable resource corresponding to the target resource level is determined based on the usage of the one or more other business resources and the device resources of the processing device, so that a remaining resource of the device other than the usage of other business resources can be used as a schedulable resource corresponding to the predetermined lowest resource level to make full use of the device resources of the processing device, and it can be ensured that the device resources of the processing device can be configured to preferentially deploy and/or run a business service corresponding to a resource level with a higher priority/importance. Therefore, running stability of a business service with a high priority on the processing device can also be ensured while improving resource utilization of the processing device.

Step 206: Determine, based on whether the target schedulable resource satisfies a deployment condition corresponding to the business service, a method for deploying the business service on the one or more processing devices.

In some embodiments, step 206 can be performed by a deployment module 506.

The deployment condition is a condition to be met when the business service is deployed on the one or more processing devices. The deployment condition can be determined based on a business requirement or a user requirement.

In some embodiments, the deployment condition can include that a relationship between the target schedulable resource of the processing device and target resource usage satisfies a predetermined condition. For example, the target schedulable resource is greater than or equal to the target resource usage.

The target resource usage of the processing device can be determined by summing usage of one or more target business resources corresponding to one or more target business services and request resources of the business service that currently needs to be deployed. The target business resource usage is resource usage corresponding to a target business service on the processing device. The first resource determining module 504 can obtain the target business resource usage by using device metadata or other feasible methods.

In some embodiments, when the target schedulable resource of each of the one or more processing devices does not satisfy the deployment condition corresponding to the business service, the deployment method can include failing in deploying the business service, that is, the business service is not deployed on the one or more processing devices.

In some embodiments, when the target schedulable resource of at least one of the one or more processing devices satisfies the deployment condition corresponding to the business service, the deployment method can include deploying the business service on the one or more processing devices that satisfy the deployment condition.

In some embodiments, when one or more processing devices that satisfy the deployment condition exist, the deployment module 506 can determine a target processing device from the one or more processing devices that satisfy the deployment condition, and deploy the business service on the target processing device.

When only one processing device that satisfies the deployment condition exists, the deployment module 506 can directly determine the processing device as the target processing device.

In some embodiments, when a plurality of processing devices that satisfy the deployment condition exist, an optimal processing device in the plurality of processing devices that satisfy the deployment condition can be determined as the target processing device. In some embodiments, the deployment module 506 can determine a score corresponding to each processing device that satisfies the deployment condition, and then determine, based on the score of each processing device that satisfies the deployment condition, an optimal processing device (for example, a processing device with a highest score) from the plurality of processing devices that satisfy the deployment condition as the target processing device. A higher score can indicate that the business service is more suitable to be deployed on the corresponding processing device. The score corresponding to the processing device can be determined in a plurality of methods. For example, for each processing device that satisfies the predetermined condition, it can be assumed that the deployment module 506 deploys, in the processing device, a current business service and an existing business service on the processing device in a deployment method such as resource stacking or resource tiling. Therefore, based on an assumed deployment result, the score corresponding to the processing device is determined by using a predetermined scoring rule (for example, higher resource utilization of the device after the business service is deployed indicates a higher score).

In some embodiments of this specification, a target schedulable resource of a processing device is determined and whether the target schedulable resource of the processing device satisfies a deployment condition corresponding to a business service is evaluated, to determine a method for deploying the business service on one or more processing devices, so that a plurality of business services can be more appropriately co-located on one or more processing devices, and colocation of a plurality of types of business services can be supported, thereby enriching modes of colocation of business services. Moreover, during colocation of a plurality of business services, normal running of the business services on the processing device can be effectively ensured, thereby improving device resource utilization, and avoiding excessive colocation of the plurality of business services/insufficient colocation of the plurality of business services. In addition, in the above method, the resource level corresponding to the business service is determined, and priorities/importance of the plurality of business services are also distinguished, thereby ensuring running stability of a business service with a high priority.

In addition, the method for colocation of a plurality of business services in this embodiment of this specification can be used to dynamically update resources by levels (that is, schedulable resources at resource levels on processing devices are dynamically updated and reported), and therefore, a plurality of business services can be more accurately co-located.

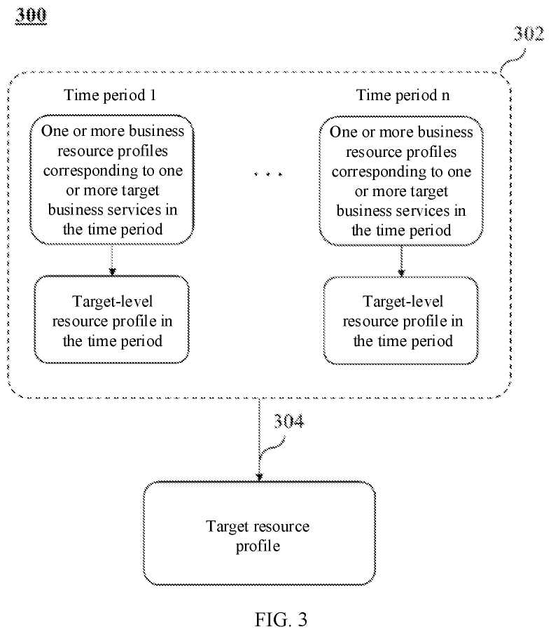

FIG. 3 is an example flowchart illustrating determining a target resource profile of a processing device, according to some embodiments of this specification.

Step 302: Obtain a target-level resource profile in each of one or more time periods.

In some embodiments, step 302 can be performed by a first resource determining module 504.

In some embodiments, in any of the time periods:

The first resource determining module 504 can obtain one or more business resource profiles corresponding to one or more target business services in the time period.

For each processing device, the first resource determining module 504 can obtain historical resource usage data of each target business service on the processing device in the time period based on device metadata or any other feasible method, and can determine, based on the historical resource usage data in the time period, a corresponding business resource profile of each target business service in the time period. For example, the corresponding business resource profile of the target business service in the time period can be determined based on the historical resource usage data of the target business service in the time period by using a resource profile determining algorithm. The resource profile algorithm can be various feasible algorithms, for example, a P99 resource usage algorithm or other machine learning algorithms.

For example, for a target business service on a processing device, the first resource determining module 504 can determine, by using half an hour as a granularity, a plurality of pieces of historical resource usage data of the target business service in the history half an hour, obtain P99 resource usage from the plurality of pieces of historical resource usage data by using the P99 resource usage algorithm, and determine the determined P99 resource usage as a corresponding business resource profile of the target business service in the time period (the history half an hour).

The first resource determining module 504 can further obtain, based on one or more business resource profiles, a resource profile (referred to as the target-level resource profile in this specification) corresponding to a target resource level in the time period. For each processing device, the first resource determining module 504 can sum one or more business resource profiles corresponding to one or more target business services, and use a result of the summation as the target-level resource profile of the processing device in the time period.

Step 304: Determine a target resource profile based on the target-level resource profile in the one or more time periods.

In some embodiments, step 304 can be performed by the first resource determining module 504.

In some embodiments, the first resource determining module 504 can obtain the target-level resource profile in one time period, and can directly determine the target-level resource profile in the time period as the target resource profile.

In some embodiments, the first resource determining module 504 can obtain target-level resource profiles in a plurality of time periods (for example, time period 1 to time period n), and can construct a resource profile curve based on the target-level resource profiles in the plurality of time periods, where a horizontal axis of the resource profile curve may be time, and a vertical axis of the resource profile curve may be resource usage. The first resource determining module 504 can determine a peak value in the resource profile curve (that is, a maximum value in the target-level resource profiles in the plurality of time periods) as the target resource profile.

In some embodiments of this specification, historical resource usage data of a target business service can be analyzed to determine a business resource profile of the target business service, so as to further determine the target resource profile. The target resource profile determined in the above method is more accurate and appropriate, so as to avoid insufficient or excessive colocation of a plurality of business services caused by an inaccurate target resource profile, thereby achieving better colocation of a plurality of business services.

FIG. 4 is an example schematic diagram illustrating a resource scheduling method for colocation of a plurality of business services, according to some other embodiment of this specification.

In some embodiments, when a plurality of business services are deployed on one or more processing devices, a resource scheduling system 600 for colocation of a plurality of business services can perform a procedure 400 to schedule resources of a plurality of co-located business services. As shown in FIG. 4, the procedure 400 can include the following steps.

Step 402: Determine a plurality of resource levels corresponding to the plurality of business services.

In some embodiments, step 402 can be performed by a second level determining module 602.

The second level determining module 602 can determine a resource level corresponding each of the plurality of co-located business services. The second level determining module 602 can obtain the resource level corresponding to each business service by using device metadata or various feasible methods.

For more content of the resource level corresponding to the business service, references can be made to FIG. 2 and related descriptions of the figure.

In some embodiments, for any of the resource levels, resources of each business service corresponding to the resource level deployed on one or more devices can be scheduled according to the method in step 404 and step 406.

Step 404: Determine a guaranteed resource and level resource usage that correspond to the resource level.

In some embodiments, step 404 can be performed by a second resource determining module 604.

The second resource determining module 604 can determine the guaranteed resource corresponding to the resource level. For more content of determining the guaranteed resource, references can be made to FIG. 2 and related descriptions of the figure.

The level resource usage refers to total resource usage of all business services corresponding to the resource level. In some embodiments, the second resource determining module 604 can determine the level resource usage corresponding to the resource level by summing resource usage of one or more business services corresponding to the resource level, for example, summing allocated resources.

The allocated resources can be resources allocated by the device to the business service (for example, resources allocated to the business service based on a resource usage request of the business service). The second resource determining module 604 can obtain, by using device metadata or various other methods, the allocated resources of the one or more business services corresponding to the resource level.

Step 406: Adjust, in a predetermined method in response to that the level resource usage and the guaranteed resource satisfy a first relationship or a second relationship, allocated resources of one or more business services that satisfy a selection condition and that correspond to the resource level, where the predetermined method corresponding to the first relationship includes increasing the allocated resources of the business service, and the predetermined method corresponding to the second relationship includes decreasing the allocated resources of the business service.

In some embodiments, step 406 can be performed by an adjustment module 606.

The adjustment module 606 can compare the level resource usage and the guaranteed resource that correspond to the resource level. When the level resource usage and the guaranteed resource satisfy the first relationship or the second relationship, the adjustment module 606 can adjust, in the predetermined method, the allocated resources of the one or more business services that satisfy the selection condition and that correspond to the resource level.

The first relationship can be a relationship that needs to indicate to increase the allocated resources of the business service corresponding to the resource level. The first relationship can include that the level resource usage corresponding to the resource level is less than or equal to the guaranteed resource. When level resource usage corresponding to a resource level is less than or equal to a guaranteed resource, the adjustment module 606 can determine, from business services corresponding to the resource level, one or more business services that satisfy the selection condition, and increase allocated resources of the one or more business services that satisfy the selection condition.

When the level resource usage and the guaranteed resource satisfy the first relationship, a corresponding business service selection condition can be predetermined. For example, when level resource usage and a guaranteed resource of a resource level satisfy the first relationship, a corresponding business service selection condition can include: resource utilization of the business service is greater than a predetermined utilization threshold (for example, 95%). The adjustment module 606 can obtain resource utilization of each business service by using device metadata or any other feasible method, for example, can obtain allocated resources and actual resource usage of each business service, so as to determine the resource utilization of each business service, that is, the actual resource usage/allocated resources.

The second relationship can be a relationship that needs to indicate to decrease the allocated resources of the business service corresponding to the resource level. The second relationship can include that the level resource usage corresponding to the resource level is greater than the guaranteed resource. When level resource usage corresponding to a resource level is greater than a guaranteed resource, the adjustment module 606 can determine, from business services corresponding to the resource level, one or more business services that satisfy the selection condition, and decrease allocated resources of the one or more business services that satisfy the selection condition.

When the level resource usage and the guaranteed resource satisfy the second relationship, a business service selection condition can be predetermined. For example, when the level resource usage and the guaranteed resource satisfy the second relationship, a corresponding business service selection condition can include: a business service whose allocated resources have been increased, and all business services corresponding to the resource level, etc. The adjustment module 606 determines, by using device metadata or any other feasible method, a business service of the resource level whose allocated resources have been increased.

In some embodiments, the adjustment module 606 can successively adjust, in the predetermined method based on a priority sequence of all of the plurality of business services, the allocated resources of the one or more business services that satisfy the selection condition and that correspond to the resource level, until a predetermined stop condition is satisfied. The adjustment module 606 can determine the priority sequence of the business services by using device metadata or any other feasible method. The priority sequence of the business services can be determined based on a business requirement or a user requirement. The predetermined stop condition can be set based on a requirement.

In some embodiments, when the level resource usage and the guaranteed resource of the resource level satisfy the first relationship, the adjustment module 606 can successively enlarge, based on a predetermined proportion (for example, 10%), the allocated resources of the one or more business services that satisfy the selection condition in descending order of the priorities of the business services, until the predetermined stop condition is satisfied. When the level resource usage and the guaranteed resource of the resource level satisfy the first relationship, the predetermined stop condition can include: stopping when all business services whose resource utilization is greater than the predetermined utilization threshold are adjusted, or stopping when adjusted level resource usage is equal to the guaranteed resource.

When the level resource usage and the guaranteed resource of the resource level satisfy the first relationship, in some embodiments of this specification, allocated resources of a business service with high resource utilization are increased, so as to make full use of idle resources, and prevent insufficient allocated resources of the business service to a certain extent, thereby ensuring stability of the business service.

In some embodiments, when the level resource usage and the guaranteed resource of the resource level satisfy the second relationship, the adjustment module 606 can successively compress, based on a predetermined proportion (for example, 80%), the allocated resources of the one or more business services that satisfy the selection condition in ascending order of the priorities of the business services, until the predetermined stop condition is satisfied. When the level resource usage and the guaranteed resource of the resource level satisfy the second relationship, the predetermined stop condition can include: stopping when adjusted level resource usage is less than the guaranteed resource.

In some embodiments, when the level resource usage and the guaranteed resource of the resource level satisfy the second relationship, the adjustment module 606 can further restore, to an original specification, allocated resources of a business service whose allocated resources have been increased.

It should be understood that, the adjustment module 606 can constantly monitor the guaranteed resource and the level resource usage, and perform, when required, dynamic resource scheduling adjustment on the business service that satisfies the selection condition and that corresponds to the resource level. For example, when allocated resources of a business service are compressed because the level resource usage corresponding to the resource is less than the guaranteed resource, allocated resources to each business service change accordingly because actual resource usage of each business service constantly changes. When the level resource usage is greater than or equal to the guaranteed resource in a time period, and resource utilization of the business service is greater than the predetermined utilization threshold, the adjustment module 606 can enlarge the allocated resources of the business service to decompress the allocated resources of the business service.

When the level resource usage and the guaranteed resource of the resource level satisfy the second relationship, in some embodiments of this specification, allocated resources of a business service whose allocated resources have been increased are compressed, so as to preferentially process a business service with low importance, thereby ensuring stability of a business service with high importance.

In some embodiments, a release module 608 can further determine a business service to be evicted from one or more business services whose allocated resources have been decreased, and can release allocated resources of the business service to be evicted. The business service to be evicted refers to a business service that needs to stop running. In some embodiments, the release module 608 can obtain, by using device metadata or any other feasible method, a business service whose allocated resources have been compressed and compression time of the business service whose allocated resources have been compressed. In some embodiments, when compression time of a business service is greater than a predetermined time threshold, the business service can be determined as a business service to be evicted, and allocated resources of the business service to be evicted are released.

In some embodiments of this specification, when computing resources are limited, some business services that run abnormally are evicted to better ensure normal running of other business services of the resource level.

Unlike a conventional colocation method that relies only on kernel isolation and scheduling, in some embodiments of this specification, resource levels of a plurality of business services are divided, where the resource levels can correspond to different guaranteed resources; and computing resources corresponding to the resource levels are separately scheduled based on level resource usage and guaranteed resources corresponding to the resource levels, to implement resource preemption. Allocated resources of the business services are dynamically adjusted, and a resource stability assurance capability is introduced into a user mode, so that stability of the plurality of business services is improved. In addition, during resource scheduling at each resource level, in some embodiments of this specification, the allocated resources can be adjusted in a priority sequence of the business services, thereby ensuring stability of a business service with a high priority.

It is worthwhile to note that, the above descriptions of the procedures are merely for example and description, and do not limit the applicable scope of this specification. A person skilled in the art can make various amendments and changes to the procedure under the guidance of this specification. However, these amendments and changes still fall within the scope of this specification, for example, changes made to related steps in the procedure in this specification, such as adding a preprocessing step, a storage step, and other data processing steps.

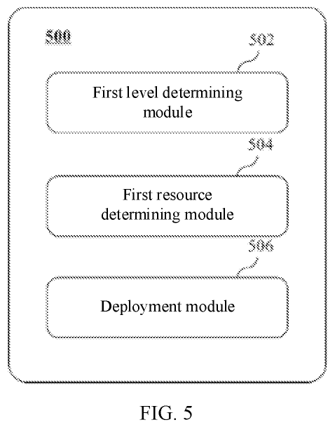

FIG. 5 is an example diagram illustrating modules of a system for colocation of a plurality of business services, according to some embodiments of this specification.

In some embodiments, the system 500 for colocation of a plurality of business services can be implemented by a processor 104. As shown in FIG. 5, the system 500 for colocation of a plurality of business services can include a first level determining module 502, a first resource determining module 504, and a deployment module 506. For one of the business services:

The first level determining module 502 can be configured to determine a target resource level corresponding to the business service.

The first resource determining module 504 can be configured to obtain a target schedulable resource of each of one or more processing devices, where the target schedulable resource is a schedulable resource corresponding to the target resource level. In some embodiments, the first resource determining module 504 can be further configured to determine a target resource profile of the processing device, where the target resource profile is a resource profile corresponding to the target resource level; determine a guaranteed resource corresponding to the target resource level; and determine the target schedulable resource based on the guaranteed resource, the target resource profile, and device resources of the processing device. In some embodiments, the first resource determining module 504 can be further configured to obtain a target-level resource profile in each of one or more time periods, and in one of the time periods, obtain one or more business resource profiles corresponding to one or more target business services in the time period, where the target business service is an existing business service corresponding to the target resource level on the processing device; obtain the target-level resource profile in the time period based on the one or more business resource profiles; and determine the target resource profile based on the target-level resource profile in the one or more time periods. In some embodiments, the first resource determining module 504 can be further configured to obtain usage of one or more other business resources corresponding to one or more other business services when the target resource level is a predetermined lowest resource level, where the other business services are existing business services corresponding to other resource levels on the processing device; and determine the target schedulable resource based on the usage of the one or more other business resources and device resources of the processing device.

The deployment module 506 can determine, based on whether the target schedulable resource satisfies a deployment condition corresponding to the business service, a method for deploying the business service on the one or more processing devices. In some embodiments, the deployment condition can include: a relationship between the target schedulable resource and target resource usage satisfies a predetermined condition, where the target resource usage is determined by summing usage of one or more target business resources corresponding to one or more target business services and request resources of the business service, and the target business service is an existing business service corresponding to the target resource level on the processing device. In some embodiments, when one or more processing devices that satisfy the deployment condition exist, the deployment method can include: determining a target processing device from the one or more processing devices that satisfy the deployment condition, and deploying the business service on the target processing device.

For specific descriptions of the modules of the system for colocation of a plurality of business services shown above, references can be to the flowchart in this specification, for example, FIG. 2, FIG. 3, and related descriptions of the figures.

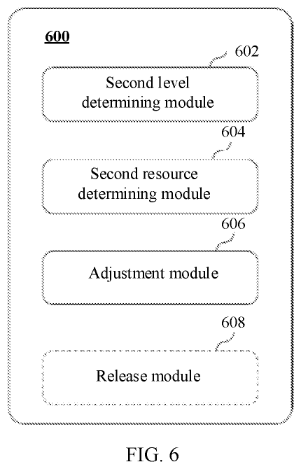

FIG. 6 is an example diagram illustrating modules of a resource scheduling system for colocation of a plurality of business services, according to some embodiments of this specification.

In some embodiments, the resource scheduling system 600 for colocation of a plurality of business services can be implemented by a processor 104. As shown in FIG. 6, the resource scheduling system 600 for colocation of a plurality of business services can include a second level determining module 602, a second resource determining module 604, and an adjustment module 606.

The second level determining module 602 can be configured to determine a plurality of resource levels corresponding to the plurality of business services.

For any one of the resource levels:

The second resource determining module 604 can be configured to determine a guaranteed resource and level resource usage that correspond to the resource level, where the level resource usage is determined by summing allocated resources of one or more business services corresponding to the resource level.

The adjustment module 606 can be configured to adjust, in a predetermined method in response to that the level resource usage and the guaranteed resource satisfy a first relationship or a second relationship, allocated resources of one or more business services that satisfy a selection condition and that correspond to the resource level, where the predetermined method corresponding to the first relationship includes increasing the allocated resources of the business service, and the predetermined method corresponding to the second relationship includes decreasing the allocated resources of the business service. In some embodiments, the adjustment module 606 can be further configured to successively adjust, in the predetermined method based on a priority sequence of all of the plurality of business services, the allocated resources of the one or more business services that satisfy the selection condition and that correspond to the resource level, until a predetermined stop condition is satisfied.

In some embodiments, the resource scheduling system 600 for colocation of a plurality of business services can further include a release module 608. The release module 608 can be configured to determine a service to be evicted from one or more business services whose allocated resources have been decreased, and release the allocated resources of the service to be evicted.

For specific descriptions of the modules of the resource scheduling system 600 for colocation of a plurality of business services, references can be to the flowchart in this specification, for example, FIG. 4 and related descriptions of the figure.

It should be understood that the systems and the modules of the systems shown in FIG. 5 and FIG. 6 can be implemented in various forms. For example, in some embodiments, the system and the modules of the system can be implemented by hardware, software, or a combination of software and hardware. The hardware part can be implemented by using dedicated logic. The software part can be stored in a memory and executed by an appropriate instruction execution system, for example, a microprocessor or specially designed hardware. A person skilled in the art can understand that the above methods and systems can be implemented by using computer-executable instructions and/or control code included in the processor. For example, such code is provided on a carrier medium such as a disk, a CD, or a DVD-ROM, a programmable memory such as a read-only memory (firmware), or a data carrier such as an optical or electronic signal carrier. The system and the modules of the system in this specification can be implemented not only by a hardware circuit of an ultra-large-scale integrated circuit or gate array, a semiconductor such as a logic chip or a transistor, or a programmable hardware device such as a field programmable gate array or a programmable logic device, but also by software executed by various types of processors, or can be implemented by a combination (for example, firmware) of the hardware circuit and software.

It is worthwhile to note that, the above descriptions of the system 500 for colocation of a plurality of business services and the resource scheduling system 600 for colocation of a plurality of business services are merely used for convenient description, and cannot limit this specification to the scope of the enumerated embodiments. It can be understood that, after understanding the principle of the system, a person skilled in the art can randomly combine the modules or form a subsystem to be connected to another module without departing from the principle. For example, in some embodiments, the first level determining module 502 and the first resource determining module 504 can be different modules in a system, or can be a module that implements functions of the above two or more modules. For example, the modules can share one storage module, or the modules can have respective storage modules. Such variations all fall within the protection scope of this specification.

Embodiments of this specification further provide an apparatus for colocation of a plurality of business services, including at least one storage medium and at least one processor. The at least one storage medium is configured to store computer instructions. The at least one processor is configured to execute the computer instructions to implement a method for colocation of a plurality of business services. The method includes: for one of the business services, a target resource level corresponding to the business service is determined; a target schedulable resource of each of one or more processing devices is obtained, where the target schedulable resource is a schedulable resource corresponding to the target resource level; and a method for deploying the business service on the one or more processing devices is determined based on whether the target schedulable resource satisfies a deployment condition corresponding to the business service.

Embodiments of this specification further provide a resource scheduling apparatus for colocation of a plurality of business services, including at least one storage medium and at least one processor. The at least one storage medium is configured to store computer instructions. The at least one processor is configured to execute the computer instructions to implement a resource scheduling method for colocation of a plurality of business services. The method includes: a plurality of resource levels corresponding to the plurality of business services are determined, and for any one of the resource levels: a guaranteed resource and level resource usage that correspond to the resource level are determined, where the level resource usage is determined by summing allocated resources of one or more business services corresponding to the resource level; and allocated resources of one or more business services that satisfy a selection condition and that correspond to the resource level are adjusted in a predetermined method in response to that the level resource usage and the guaranteed resource satisfy a first relationship or a second relationship, where the predetermined method corresponding to the first relationship includes increasing the allocated resources of the business service, and the predetermined method corresponding to the second relationship includes decreasing the allocated resources of the business service.

Beneficial effects that can be brought by embodiments of this specification include but are not limited to the following: (1) In some embodiments of this specification, a target schedulable resource of a processing device is determined and whether the target schedulable resource of the processing device satisfies a deployment condition corresponding to a business service is evaluated, to determine a method for deploying the business service on one or more processing devices, so that a plurality of business services can be more appropriately co-located on one or more processing devices, and colocation of a plurality of types of business services can be supported, thereby enriching modes of colocation of business services. Moreover, during colocation of a plurality of business services, normal running of the business services on the processing device can be effectively ensured, thereby improving device resource utilization, and avoiding excessive colocation of the plurality of business services/insufficient colocation of the plurality of business services. In addition, in the above method, the resource level corresponding to the business service is determined, and priorities/importance of the plurality of business services are also distinguished, thereby ensuring running stability of a business service with a high priority. (2) Unlike a conventional colocation method that relies only on kernel isolation and scheduling, in the resource scheduling method for colocation of a plurality of business services proposed in some embodiments of this specification, resource levels of a plurality of business services are divided, where resource levels can correspond to different guaranteed resources; and computing resources corresponding to the resource levels are separately scheduled based on level resource usage and guaranteed resources corresponding to the resource levels, to implement resource preemption. Allocated resources of the business services are dynamically adjusted, and a resource stability assurance capability is introduced into a user mode, so that stability of the plurality of business services is improved. In addition, during resource scheduling at each resource level, in some embodiments of this specification, the allocated resources can be adjusted in a priority sequence of the business services, thereby ensuring stability of a business service with a high priority.

It is worthwhile to note that beneficial effects that can be generated in different embodiments are different. The beneficial effects that can be generated in different embodiments can be any one or a combination of several of the above beneficial effects, or can be any other beneficial effect possibly achieved.

Basic concepts have been described above. Clearly, for a person skilled in the art, the above detailed disclosure is merely an example, but does not constitute a limitation on this specification. Although not expressly stated here, a person skilled in the art can make various modifications, improvements, and amendments to this specification. Such modifications, improvements, and amendments are proposed in this specification. Therefore, such modifications, improvements, and amendments still fall within the spirit and scope of the example embodiments of this specification.

In addition, specific words are used in this specification to describe the embodiments of this specification. For example, terms such as “one embodiment”, “an embodiment”, and/or “some embodiments” mean a certain feature, structure, or characteristic related to at least one embodiment of this specification. Therefore, it is worthwhile to emphasize and note that “one embodiment”, “an embodiment”, or “an alternative embodiment” mentioned twice or more times in different locations in this specification does not necessarily refer to the same embodiment. In addition, some features, structures, or characteristics in one or more embodiments of this specification can be appropriately combined.

In addition, a person skilled in the art can understand that the aspects of this specification can be illustrated and described by using several patentable categories or cases, including a combination of any new and useful processes, machines, products, or substances, or any new and useful improvements to the processes, machines, products, or substances. Correspondingly, the aspects of this specification can be executed by hardware only, can be executed by software (including firmware, resident software, microcode, etc.) only, or can be executed by a combination of hardware and software. The above hardware or software can be referred to as a “data block”, a “module”, an “engine”, a “unit”, a “component”, or a “system”. In addition, the aspects of this specification can be represented by a computer product located in one or more computer-readable media, and the product includes computer-readable program code.

The computer storage medium may include a propagated data signal that includes computer program code, for example, located on a baseband or used as a part of a carrier. The propagated signal can have a plurality of representation forms, including an electromagnetic form, an optical form, etc., or an appropriate combination form. The computer storage medium can be any computer-readable medium other than a computer-readable storage medium. The medium can be connected to an instruction execution system, apparatus, or device to implement communication, propagation, or transmission of a program for use. The program code located on the computer storage medium can be propagated through any appropriate medium, including radio, a cable, a fiber cable, RF, or similar media, or any combination of the above media.

The computer program code needed for operation of each part of this specification can be written in any one or more programming languages, including object-oriented programming languages such as Java, Scala, Smalltalk, Eiffel, JADE, Emerald, C++, C#, VB.NET, and Python, conventional programming languages such as the C language, Visual Basic, Fortran 2003, Perl, COBOL 2002, PHP, ABAP, and dynamic programming languages such as Python, Ruby, and Groovy, or other programming languages. The program code can run entirely on a user computer, or run as an independent software package on a user computer, or partially run on a user computer and partially run on a remote computer, or run entirely on a remote computer or server. In the latter case, the remote computer can be connected to a user computer through any form of network, such as a local area network (LAN) or a wide area network (WAN), or connected to an external computer (for example, through the Internet), or in a cloud computing environment, or used as a service, such as software as a service (SaaS).

In addition, unless expressly stated in the claims, the order of the processing elements and sequences, the use of numerals and letters, or the use of other names described in this specification is not intended to limit the order of the procedures and methods described in this specification. Although some embodiments of this specification considered useful currently are discussed by using various examples in the above disclosure, it should be understood that such details are merely used for illustration. The additional claims are not limited to the disclosed embodiments, and instead, the claims are intended to cover all amendments and equivalent combinations that conform to the essence and scope of the embodiments of this specification. For example, although the system components described above can be implemented by a hardware device, the system components can also be implemented by a software solution, for example, installing the described system on an existing server or mobile device.

Similarly, it is worthwhile to note that, to simplify the description disclosed in this specification and help understand one or more embodiments of this specification, in the above descriptions of the embodiments of this specification, a plurality of features are sometimes incorporated into one embodiment, drawing, or descriptions of the embodiment and the drawing. However, this disclosure method does not mean that features needed by the object in this specification are more than the features mentioned in the claims. In fact, the features of the embodiments are less than all features of individual embodiments disclosed above.

Numerals describing quantities of components and attributes are used in some embodiments. It should be understood that such numerals used for the description of the embodiments are modified in some examples by modifiers such as “about”, “approximately”, or “generally”. Unless otherwise stated, “about”, “approximately”, or “generally” indicates that a change of ±20% is allowed for the numeral. Correspondingly, in some embodiments, numeric parameters used in this specification and the claims are approximations, and the approximations can change based on features needed by some embodiments. In some embodiments, the numeric parameters should take into account the specified significant digits and use a general digit retention method. Although in some embodiments of this specification, numeric domains and parameters used to determine the ranges of the embodiments are approximations, in specific implementations, such values are set as precisely as possible in a feasible range.

Each patent, patent specification, and patent specification publication and other materials such as articles, books, specifications, publications, or documents are incorporated into this specification here by reference in their entireties, except for the historical specification documents inconsistent or conflicting with the content of this specification, and the documents (attached to this specification currently or later) that limit the widest scope of the claims of this specification. It is worthwhile to note that, if the description, definition, and/or use of the terms in the attachments of this specification are inconsistent or conflict with the content of this specification, the description, definition, or use of the terms of this specification shall prevail.

Finally, it should be understood that the embodiments described in this specification are merely used to describe the principles of the embodiments of this specification. Other variations may also fall within the scope of this specification. Therefore, by way of example instead of limitation, alternative configurations of the embodiments of this specification can be considered to be consistent with the teachings of this specification. Correspondingly, the embodiments of this specification are not limited to the embodiments expressly described in this specification.

What is claimed is:

1. A method for colocation of a plurality of business services, wherein the method comprises:
for one of the business services:
determining a target resource level corresponding to the business service;
obtaining a target schedulable resource of each of one or more processing devices, wherein the target schedulable resource is a schedulable resource corresponding to the target resource level; and
determining, based on whether the target schedulable resource satisfies a deployment condition corresponding to the business service, a method for deploying the business service on the one or more processing devices.

2. The method according to claim 1, wherein for one of the processing devices, the obtaining the target schedulable resource of the processing device comprises:
determining a target resource profile of the processing device, wherein the target resource profile is a resource profile corresponding to the target resource level;
determining a guaranteed resource corresponding to the target resource level; and
determining the target schedulable resource based on the guaranteed resource, the target resource profile, and device resources of the processing device.

3. The method according to claim 2, wherein the determining a target resource profile of the processing device comprises: obtaining a target-level resource profile in each of one or more time periods, and in one of the time periods,
obtaining one or more business resource profiles corresponding to one or more target business services in the time period, wherein the target business service is an existing business service corresponding to the target resource level on the processing device;
obtaining the target-level resource profile in the time period based on the one or more business resource profiles; and
determining the target resource profile based on the target-level resource profile in the one or more time periods.

4. The method according to claim 1, wherein when the target resource level is a predetermined lowest resource level, for one of the processing devices, the obtaining the target schedulable resource of the processing device comprises:
obtaining usage of one or more other business resources corresponding to one or more other business services, wherein the other business services are existing business services corresponding to other resource levels on the processing device; and
determining the target schedulable resource based on the usage of the one or more other business resources and device resources of the processing device.

5. The method according to claim 1, wherein the deployment condition comprises: a relationship between the target schedulable resource and target resource usage satisfies a predetermined condition, wherein the target resource usage is determined by summing usage of one or more target business resources corresponding to one or more target business services and a request resource of the business service, and the target business service is an existing business service corresponding to the target resource level on the processing device.

6. The method according to claim 5, wherein when one or more processing devices that satisfy the deployment condition exist, the deployment method comprises:
determining a target processing device from the one or more processing devices that satisfy the deployment condition, and deploying the business service on the target processing device.

7. A computing device, comprising a memory and a processor, wherein the memory stores executable instructions that, in response to execution by the processor, cause the processor to:
determine a target resource level corresponding to the business service;
obtain a target schedulable resource of each of one or more processing devices, wherein the target schedulable resource is a schedulable resource corresponding to the target resource level; and
determine, based on whether the target schedulable resource satisfies a deployment condition corresponding to the business service, a method for deploying the business service on the one or more processing devices.

8. A non-transitory computer readable storage medium comprising instructions stored therein that, when executed by a processor of a computing device, cause the processor to:
determine a target resource level corresponding to the business service;
obtain a target schedulable resource of each of one or more processing devices, wherein the target schedulable resource is a schedulable resource corresponding to the target resource level; and
determine, based on whether the target schedulable resource satisfies a deployment condition corresponding to the business service, a method for deploying the business service on the one or more processing devices.
